(19) United States
(12) Patent Application Publication
(10) Pub. No.: US 2025/0261242 A1
(43) Pub. Date: Aug. 14, 2025

(54) METHOD PERFORMED BY USER EQUIPMENT, METHOD PERFORMED BY ACCESS NETWORK NODE, USER EQUIPMENT, AND ACCESS NETWORK NODE

(71) Applicant: NEC Corporation, Minato-ku, Tokyo (JP)

(72) Inventors: Pravjyot DEOGUN, London (GB); Yuhua CHEN, London (GB); Hisashi FUTAKI, Tokyo (JP); Neeraj GUPTA, London (GB); Maxime GRAU, London (GB)

(73) Assignee: NEC Corporation, Minato-ku, Tokyo (JP)

(21) Appl. No.: 18/856,950

(22) PCT Filed: Apr. 21, 2023
(86) PCT No.: PCT/JP2023/016021

§ 371 Date: Oct. 15, 2024

(30) Foreign Application Priority Data
Apr. 29, 2022 (GB) 2206366.3

(51) Int. Cl. H04W 74/0833; H04W 52/14; H04W 52/36

(52) U.S. Cl. CPC H04W 74/0833; H04W 52/146; H04W 52/367

(57) ABSTRACT

A method performed by a user equipment (UE) (3) is provided. The method includes: receiving, from an access network node (5, 9), random-access configuration information identifying a plurality of physical random-access (PRACH) preamble formats for use by the UE (3) in a random-access procedure. Each of the plurality of the PRACH preamble formats is associated with a respective resource within a period to which the random-access configuration information is applicable. The each of the plurality of the PRACH preamble formats is associated with a respective number of repetition.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to random-access procedures in the so-called ‘5G’ (or ‘Next Generation (NG)’ or ‘New Radio’ (NR)) systems for example random-access procedures for very large cells such as those that arise when NR is provided via a non-terrestrial network portion comprising airborne or spaceborne network nodes.

### BACKGROUND ART

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 1 (3GPP Technical Specification (TS) 38.300 V16.7.0) and NPL 2 (3GPP TS 37.340 V16.7.0) define the following nodes, amongst others:
gNB: node providing NR user plane and control plane protocol terminations towards the UE and connected via the NG interface to the 5G core network (5GC).
ng-eNB: node providing Evolved Universal Terrestrial Radio Access (E-UTRA) user plane and control plane protocol terminations towards the UE and connected via the NG interface to the 5GC.
En-gNB: node providing NR user plane and control plane protocol terminations towards the UE and acting as Secondary Node in E-UTRA-NR Dual Connectivity (EN-DC).
NG-RAN node: either a gNB or an ng-eNB.

3GPP is also working with the satellite communication industry to specify an integrated satellite and terrestrial network infrastructure in the context of 5G. This is referred to as non-terrestrial networks (NTN) which term refers to networks, or segments of networks, using an airborne or spaceborne vehicle for transmission of data and control signalling. Satellites refer to spaceborne vehicles in Low Earth Orbits (LEO), Medium Earth Orbits (MEO), Geostationary Earth Orbit (GEO) or in Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS-all operating quasi-stationary at an altitude typically between 8 and 50 km.

NPL 3 (3GPP Technical Report (TR) 38.811 V15.4.0) is a study on New Radio to support such non-terrestrial networks. The study includes, amongst other things, NTN deployment scenarios and related system parameters (such as architecture, altitude, orbit etc.) and a description of adaptation of the 3GPP channel models for non-terrestrial networks (propagation conditions, mobility, etc.). NPL 4 (3GPP TR 38.821 V16.1.0) provides further details about NTN.

Non-terrestrial networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

Non-Terrestrial Network access typically features the following elements (amongst others):
NTN Terminal: This may refer to the 3GPP UE or to a UE specific to the satellite system in the case that the satellite does not serve directly 3GPP UEs.
A service link which refers to the radio link between the user equipment and the space/airborne platform (which may be in addition to a radio link with a terrestrial based RAN).
A space or an airborne platform.
Gateways that connect the satellite or aerial access network to the core network. It will be appreciated that gateways will mostly likely be collocated with a base station (e.g. a gNB).
Feeder links which refer to the radio links between the Gateways and the space/airborne platform.

Satellite or aerial vehicles typically generate several beams over a given area. The beams have a typically elliptic footprint on the surface of the earth. The beam footprint may be moving over the earth with the satellite or the aerial vehicle motion on its orbit. Alternatively, the beam footprint may be earth fixed, in such case some beam pointing mechanisms (mechanical or electronic steering feature) may be used to compensate for the satellite or the aerial vehicle motion.

Once a UE has detected and selected a cell (and/or a beam in the case of 5G) it may attempt to access that cell and/or beam using an initial radio resource control (RRC) connection setup procedure comprising a random-access procedure that typically involves four distinct steps. In the case of 5G prior to attempting initial access the UE may perform transmission of a preamble to the network (e.g. a base station such as a gNB) over a physical random-access channel (PRACH) for initiating a process to obtaining synchronization in the uplink (UL). This step is often referred to as PRACH transmission or simply transmission of message 1 (Msg1). In response, the network responds with a random-access response (RAR) indicating reception of the preamble and providing a timing-alignment (TA) command for adjusting the transmission timing of the UE based on the timing of the received preamble. This step is often referred to as message 2 (Msg2) transmission. The UE then sends a third message (message 3 or ‘Msg3’) to the network over a physical uplink shared channel (PUSCH). The specific message sent by the UE in this step, and the content of the message, depends on the context in which the random-access procedure is being used. In the example of initial radio RRC connection setup, however, Msg3 comprises an RRC Setup Request or similar message carrying a temporary randomly generated UE identifier. The network responds with a fourth message (message 4 or ‘Msg4’) which carries the randomly generated UE identifier received in Msg3 for contention purposes to resolve any collisions between different UEs using the same preamble sequence. When successful, Msg4 also transfers the UE to a connected state.

A similar random-access procedure may also be used in other contexts within NR including, for example, handover, connection reestablishment, requesting UL scheduling where no dedicated resource for a scheduling-request has been configured for the UE, etc.

A so-called two-step random access procedure has been introduced (in addition to the above described four-step random access procedure). The two-step random access is mainly intended for supporting (Ultra) Low Latency Communications, 10 ms control plane latency, fast handover, efficient channel access in unlicensed spectrum, and transmission of small data packets, amongst others. However, it may also apply to large cells such as non-terrestrial cells. The main difference is that whilst the four-step random access procedure requires two round-trip cycles between the UE and the base station, the two-step random access procedure aims to reduce latency and control-signaling overhead by using a single round trip cycle between the UE and the base station.

Effectively, this is achieved by combining the UE's PRACH preamble (Msg1) transmission and the scheduled PUSCH transmission (Msg3) into a single message (referred to as ‘MsgA’). Similarly, the random-access response (RAR/Msg2) from the base station to UE and the contention resolution message (Msg4) are combined in the two-step random access procedure (and referred to as ‘MsgB’).

As those skilled in the art will appreciate, while a contention based PRACH procedure is described, a non-contention based (or ‘contention free’) procedure may also be used in which a dedicated preamble is assigned by the base station to the UE.

In 5G NR there are currently 64 preambles defined for each time-frequency PRACH occasion. Each preamble transmission comprises two parts-a cyclic prefix (CP) part and a preamble sequence part. The sequence part contains the preamble signature, which can be repeated (e.g. in preamble formats used for low signal-to-noise-ratio (SNR) situations). Since the UE may be located anywhere in a cell, and cell size can vary greatly, there is an inherent uncertainty in how long it will take for a given preamble transmission to be received. To allow for this uncertainty in preamble reception timing a guard period (GP) or ‘guard time (GT)’ is provided, following the preamble transmission, during which no signal is sent. The guard period is designed (together with the CP) to take into account maximum expected UL timing misalignment (i.e. based on the distance a UE might be from the base station when the UE is at the cell edge as represented by the cell radius). An UL timing misalignment that is greater than the maximum expected and thus falling outside the range provided for by the GP will cause the preamble to leak onto the next frame—this is referred to as preamble ambiguity.

A number of preamble formats are defined, each preamble format being defined by a different respective CP+Sequence+GP set. There are currently a total 13 preamble formats defined for 5G for two different preamble types (‘short’ and ‘long’). There are 4 preamble formats (referred to as formats 0 through 3) defined for long preambles and 9 preamble formats (referred to as formats A1 to A3, B1 to B3, CO and C2) defined for short preambles. FIGS. 6 and 7 illustrate the preamble formats for long and short preambles, respectively.

The current random-access procedures have the potential to cause a number of issues that become particularly significant as cell sizes increase and/or the number of UEs operating in a cell increases significantly. These issues are particularly relevant to (but are not limited to) cells of NTNs.

The type of preamble used in the cell is currently configured as part of the cell random-access configuration and thus, within a given cell, only one type of preamble can be used for initial access. Traditional random-access resources are designed to accommodate for a worst-case scenario in which the UE is at the cell edge, potentially causing a bottleneck in a large and populated cell. In legacy cells, this one-size-fits-all approach may not have been a limiting problem because UEs were not expected to have pre-compensation capability (and the location of the base station was not known to the UE anyway), there were typically fewer UEs in a cell, and because the size of legacy cells was limited. However, this is no longer the case as cell size increases (especially for NTNs) and cells become more populated. Even in very large cells, UEs with precise timing advance pre-compensation (based on UE position) can theoretically achieve 64 or more preambles per sequence root in a compact preamble format, which would lead to more efficient and available random-access resources for these UEs and the present one-size-fits-all approach lacks the flexibility to achieve this benefit.

In 5G, the deployment of terrestrial networks can be driven by the coverage of population centres rather than by the coverage of geographical areas. This can lead to the creation of geographical areas where access to the 5G services through the radio coverage of a terrestrial network will not be possible. In such cases, UEs whether associated with pedestrian users, or embarked on moving land mobile terrestrial platforms (e.g. a car, a coach, a truck, a train), airborne platforms (e.g. a commercial or a private jet) or maritime platforms (e.g. a maritime vessel) can experience conditions where 5G services cannot be offered continuously by a single or a combination of terrestrial networks during the journey of the UE.

3GPP has specified service requirements for next generation new services and markets which include that the 5G system shall be able to provide services using satellite access. 3GPP also specifies that the 5G system shall support service continuity between land based 5G access and satellite based access networks owned by the same operator or by an agreement between operators.

The objectives for NTN for Release-18 include support for the use case of voice and low-data rate services using commercial smartphones with more realistic assumptions on antenna gains. In NTN both very small aperture terminal (VSAT) UEs (with higher power capability e.g. 33 dBm) and commercial UEs (with limited power e.g. 23 dBm) can coexist within the same cell. Commercial UEs are expected to connect to NTN in case of absence of TN coverage. However, commercial UEs with limited power can experience higher number of random-access failures (as compared to VSAT UEs). This can deteriorate even further for the case of the so-called Ka-band. Hence, random-access enhancements are required for ensuring connection to NTN by commercial UEs.

The PRACH transmission power is determined based on maximum UE transmission power, observed path loss, and power ramping procedure. Note that for satellite communication (for large payload to UE distance), the required power to transmit PRACH can be significantly high due to the high associated path loss.

Due to the nature of the (contention based) random-access procedure, there may be relatively frequent collisions between random-access preamble transmissions by different UEs using overlapping resources. In this case, UEs that employ a relatively smaller maximum transmit power will be more likely to fail to complete random-access even when they employ ramping up of the transmission power. Thus, the current approach is not ideal for supporting the service continuity requirement for NTN.

Although it is possible to configure RACH resources for enhanced coverage (e.g. higher repetitions), this would be wasteful of scarce uplink resources when the density of commercial UEs connecting to NTN (due to service continuity) is low as compared to VSAT UEs.

### CITATION LIST

### Non Patent Literature

NPL 1: 3GPP Technical Specification (TS) 38.300 V16.7.0
NPL 2: 3GPP TS 37.340 V16.7.0
NPL 3: 3GPP Technical Report (TR) 38.811 V15.4.0
NPL 4: 3GPP TR 38.821 V16.1.0

### SUMMARY OF INVENTION

### Technical Problem

Accordingly, the present disclosure seeks to provide methods and associated apparatus that address or at least alleviate (at least one or more of) the above described issues.

Although for efficiency of understanding for those of skill in the art, the present disclosure will be described in detail in the context of a 3GPP system (5G networks including NTN), the principles of the present disclosure can be applied to other systems as well. Although the present disclosure is motivated by NTN use cases, the example embodiments can be applied to any large cells and to support relatively low power UEs (e.g. IoT devices) in regular terrestrial cells.

### Solution to Problem

Aspects of the present disclosure are set out in the appended independent claims optional but beneficial features are set out in the appended dependent claims.

In one aspect, the present disclosure provides a method performed by a user equipment (UE), the method comprising: receiving, from an access network node, random-access configuration information identifying a plurality of physical random-access (PRACH) preamble formats for use by the UE in a random-access procedure, wherein each PRACH preamble format is associated with a respective resource within a period to which the random-access configuration information is applicable, and the each PRACH preamble format is associated with a respective number of repetition.

In one aspect, the present disclosure provides a method performed by an access network node, the method comprising: transmitting, to a user equipment (UE), random-access configuration information identifying a plurality of physical random-access (PRACH) preamble formats for use by the UE in a random-access procedure, wherein each PRACH preamble format is associated with a respective resource within a period to which the random-access configuration information is applicable, and the each PRACH preamble format is associated with a respective number of repetition.

In one aspect, the present disclosure provides a user equipment (UE) comprising means (for example a memory, a controller, and a transceiver) for receiving, from an access network node, random-access configuration information identifying a plurality of physical random-access (PRACH) preamble formats for use by the UE in a random-access procedure, wherein each PRACH preamble format is associated with a respective resource within a period to which the random-access configuration information is applicable, and the each PRACH preamble format is associated with a respective number of repetition.

In one aspect, the present disclosure provides an access network node comprising means (for example a memory, a controller, and a transceiver) for transmitting, to a user equipment (UE), random-access configuration information identifying a plurality of physical random-access (PRACH) preamble formats for use by the UE in a random-access procedure, wherein each PRACH preamble format is associated with a respective resource within a period to which the random-access configuration information is applicable, and the each PRACH preamble format is associated with a respective number of repetition.

Aspects of the present disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the present disclosure independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

### BRIEF DESCRIPTION OF DRAWINGS

Example embodiments of the present disclosure will now be described, by way of example, with reference to the accompanying drawings in which:

FIG. 1 illustrates schematically a mobile (cellular or wireless) telecommunication system to which example embodiments of the present disclosure may be applied.

FIG. 2A illustrates a possible implementation of an access network that may be used in the system of FIG. 1.

FIG. 2B illustrates a possible implementation of an access network that may be used in the system of FIG. 1.

FIG. 2C illustrates a possible implementation of an access network that may be used in the system of FIG. 1.

FIG. 3 is a simplified block schematic illustrating the main components of a user equipment that may be used in the system shown in FIGS. 1, and 2A to 2C.

FIG. 4 is a simplified block schematic illustrating the main components of a base station/access network node that may be used in the system shown in FIGS. 1, and 2A to 2C.

FIG. 5 is a simplified block schematic illustrating the main components of a base station of a distributed type that may be used in the system shown in FIGS. 1, and 2A to 2C.

FIG. 6 illustrates schematically different preamble formats that may be used for long preambles.

FIG. 7 illustrates schematically different preamble formats that may be used for short preambles.

FIG. 8 illustrates a respective way in which random-access channel configurations may be signalled in the system shown in FIGS. 1, and 2A to 2C.

FIG. 9 illustrates a respective way in which random-access channel configurations may be signalled in the system shown in FIGS. 1, and 2A to 2C.

FIG. 10 illustrates a respective way in which random-access channel configurations may be signalled in the system shown in FIGS. 1, and 2A to 2C.

FIG. 11 illustrates a respective way in which random-access channel configurations may be signalled in the system shown in FIGS. 1, and 2A to 2C.

FIG. 12 illustrates schematically some exemplary architecture options for the provision of NTN features in the system shown in FIGS. 1, and 2A to 2C.

### DESCRIPTION OF EMBODIMENTS

### Overview

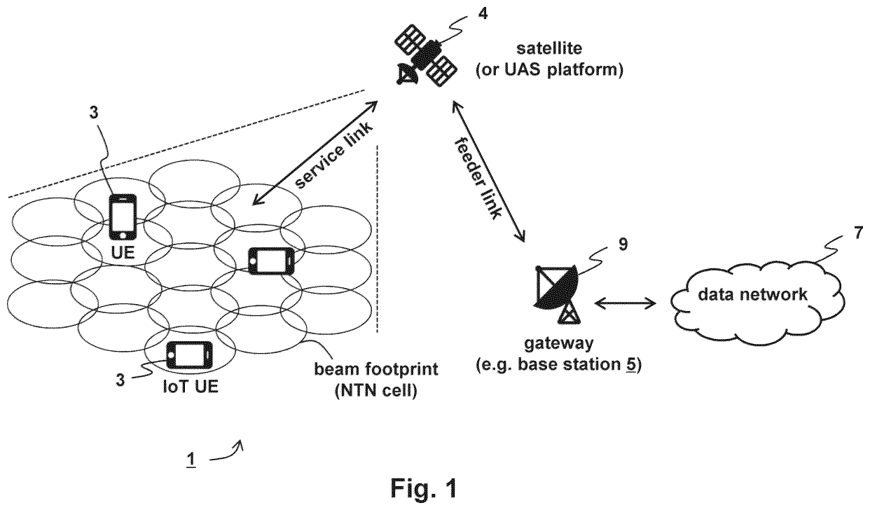

FIG. 1 illustrates schematically a mobile (cellular or wireless) telecommunication system 1 to which example embodiments of the present disclosure may be applied.

In this system 1, users of mobile devices 3 (UEs) can communicate with each other and other users via access network nodes respective satellites 4 and/or base stations 5 and a data network 7 using an appropriate 3GPP radio access technology (RAT), for example, an E-UTRA (4G) and/or NR (5G) RAT. In case of an E-UTRA RAT, the base station 5 may be referred to as an ‘eNB’ or ‘ng-eNB’ and in case of an NR RAT, the base station 5 may be referred to as a ‘gNB’. The UEs 3 may comprise NB-IoT or MTC UEs or they may include appropriate NB-IoT or MTC functionality. Satellites connect to the data network 7 via a gateway 9, which is usually implemented as part of a base station 5. As those skilled in the art will appreciate, whilst three UEs 3, one satellite 4, and one base station 5 (gateway 9) are shown in FIG. 1 for illustration purposes, the system, when implemented, will typically include other satellites (spaceborne/airborne platforms), radio access network nodes (base stations/gateways), and mobile devices (UEs). It will be appreciated that the non-terrestrial (space or air borne) platform 4 may comprise one or more satellites and/or airborne vehicles.

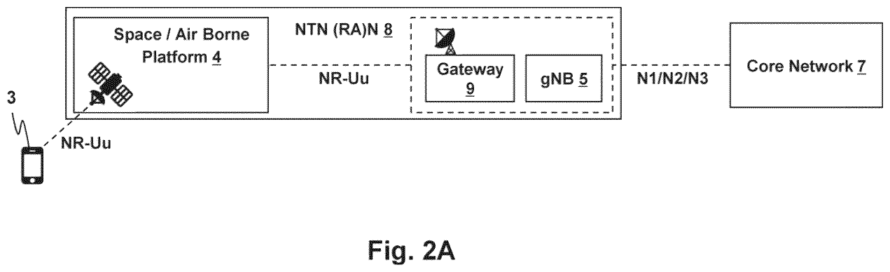

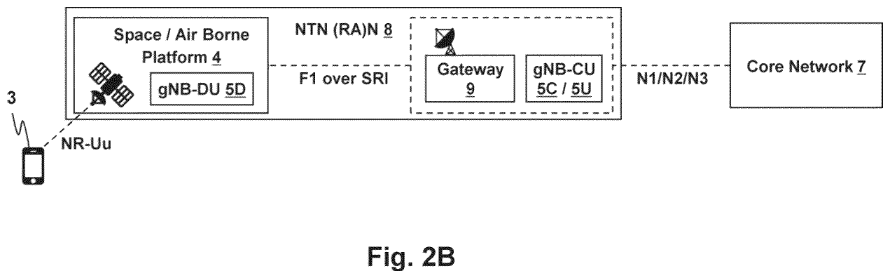

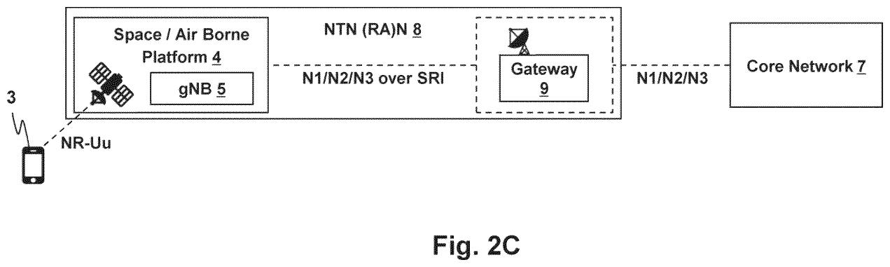

It will be appreciated that a number of base stations 5 form a (radio) access network or (R)AN, and a number of NTN nodes 4 (satellites and/or UAS platforms) form a Non-Terrestrial Network (NTN). Each NTN node 4 is connected to an appropriate gateway 9 (in this case co-located with a base station 5) using a so-called feeder link and connected to respective UEs 3 via corresponding service links. Thus, when served by an NTN node 4, a mobile device 3 communicates data to and from a base station 5 via the NTN node 4, using an appropriate service link (between the mobile device 3 and the NTN node 4) and a feeder link (between the NTN node 4 and the gateway 9/base station 5). In other words, the non-terrestrial network forms part of the (R)AN, although it may also provide satellite communication services independently of E-UTRA and/or 5G communication services. Further details of an exemplary (radio) access network 8 that includes a non-terrestrial network portion will be provided with reference to FIGS. 2A to 2C.

Although not shown in FIG. 1, neighbouring base stations 5 are connected to each other via an appropriate base station to base station interface (such as the so-called ‘X2’ interface, ‘Xn’ interface, and/or the like). The base stations 5 are also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). Typically, the data network 7 will include user plane entities and control plane entities. The so-called Mobility Management Entity (MME) in 4G, or the Access and Mobility Management Function (AMF) in 5G, is responsible for handling connection and mobility management tasks for the mobile devices 3, including configuring any power saving mechanisms. The data network 7 is also coupled to other data networks such as the Internet or similar Internet Protocol (IP) based networks (not shown in FIG. 1).

Each NTN node 4 controls a number of directional beams (at least one beam) via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 4 is travelling along its orbit. Alternatively, the beam footprint may be earth fixed, in which case an appropriate beam pointing mechanism (mechanical or electronic steering) may be used to compensate for the movement of the NTN node 4.

Turning now to FIGS. 2A to 2C, the following is an overview of some architectural options for an access network 8 that may be used in the system of FIG. 1. As can be seen, the UEs 3 can communicate via an NTN RAN 8 that operates according to one or more compatible radio access technologies (RATs) for example, an E-UTRA and/or 5G RAT. In the illustrated example, the NTN RAN 8 includes a non-terrestrial (space or air borne) platform 4 (e.g. comprising one or more satellites and/or airborne vehicles), a base station or ‘gNB’ 5 operating one or more associated cells, and a gateway 9. Communication via the NTN RAN 8 is typically routed through the core network 7 (e.g. a 5G core network or evolved packet core network (EPC)) which corresponds to the data network shown in FIG. 1.

As seen in FIGS. 2A to 2C, the NTN RAN 8 may be implemented in a number of different ways.

For example, as seen in FIG. 2A, the base station 5 may comprise a terrestrially located base station 5 that sends and receives communications respectively destined for and originating from the UEs (3) via a terrestrially located gateway 9 and via a non-terrestrial platform 4 that has no base station functionality. The non-terrestrial platform 4 relays these communications to and from the UEs 3 in the cell(s) operated by the base station 5, and from and to the gateway 9 as required. The non-terrestrial platform 4 relays these communications transparently without on-board processing them in effect acting as a so-called ‘bent-pipe’. In this implementation, the feeder link between the gateway 9 and the non-terrestrial platform 4 effectively acts as part of the NR-Uu interface (or reference point) between the base station 5 and the UE(s) 3. Similarly, the service link between the non-terrestrial platform 4 and the UE(s) 3 effectively acts as another part of the NR-Uu interface (or reference point) between the base station 5 and the UE(s) 3. The base station's communication link with the core network 7 (e.g. for signalling over the N1, N2, N3 interface/reference point etc.) is provided solely terrestrially.

As seen in FIG. 2B the base station 5 may, for example, comprise a base station 5 of a distributed type having a terrestrially located central unit (CU) 5C/5U and a distributed unit (DU) 5D provided on-board the non-terrestrial platform 4. The terrestrially located CU 5C/5U (having a control-plane portion 5C and a user-plane portion 5U) performs some of the (typically higher layer) functionality of the base station 5 whereas the non-terrestrially located DU 5D performs other (typically lower layer) functionality of the base station 5. The terrestrially located CU 5C/5U communicates with the non-terrestrially located DU 5D via the gateway 9 and an F1 interface implemented via a satellite radio interface between the gateway 9 and the non-terrestrial platform 4 in which the DU 5D is provided.

The non-terrestrial platform 4 transmits communications destined for and originating from the UEs (3) in the cell(s) operated by the base station 5, and from and to the gateway 9 as required. However, in this implementation lower layer processing of communication respectively destined for and originating from the UEs (3) is performed on-board the non-terrestrial platform 4 by the DU 5D and higher layer processing of that communication respectively destined for and originating from the UEs (3) is performed by the terrestrially located CU 5C/5U.

Accordingly, in this implementation, the feeder link between the gateway 9 and the non-terrestrial platform 4 effectively acts as the F1 interface (or reference point) between the CU and DU of the base station 5. The service link between the non-terrestrial platform 4 and the UE(s) 3, on the other hand, effectively acts as the NR-Uu interface (or reference point) between the base station 5 and the UE(s) 3. The base station's communication link with the core network 7 (e.g. for signalling over the N1, N2, N3 interface/reference point etc.) is provided solely terrestrially.

As seen in FIG. 2C the base station 5 may, for example, be provided on-board the non-terrestrial platform 4. The base station 5 (gNB) on board the non-terrestrial platform 4 transmits communications destined for and originating from the UEs (3) in the cell(s) operated by the base station 5, and from and to the core network 7 via the gateway 9 as required. However, in this implementation, processing of communication respectively destined for and originating from the UEs (3) is performed on-board the non-terrestrial platform 4 by the base station 5.

Accordingly, in this implementation, the feeder link between the gateway 9 and the non-terrestrial platform 4 effectively acts as part of the N1/N2/N3 interfaces (or reference points) between the base station 5 and the core network 7. The base station's communication link with the core network 7 (e.g. for signalling over the N1, N2, N3 interface/reference point etc.) is thus provided partly via the feeder link and partly terrestrially. The service link between the non-terrestrial platform 4 and the UE(s) 3, on the other hand, effectively acts as the NR-Uu interface (or reference point) between the base station 5 and the UE(s) 3.

The base station 5 thus controls one or more associated cell(s) via the non-terrestrial platform 11. It will be appreciated that the base station 5 may be configured to support both 4G and 5G, and/or any other 3GPP or non-3GPP communication protocols.

The UE(s) 3 and the base station 5 are mutually configured for performing both contention based random access (RA) procedures and contention free RA (CFRA) procedures (e.g. as described in the introduction). For example, an appropriate contention-based or contention free RA procedure may be used to gain initial access to a cell, to re-establish a communication link (e.g. an RRC connection), during a handover procedure, to communicate downlink data that has arrived at the base station to the UE, for the purposes of addition of an NR cell for a non-standalone (NSA) implementation where the base station instructs the UE to initiate an RA procedure through a physical downlink control channel (PDCCH) carrying an allocated preamble, etc.

Beneficially, the system 1 allows different types of random-access resources to be used for different UEs, by providing support for multiple preamble formats within a given cell (and per bandwidth part (BWP)). Specifically, unlike legacy systems in which the base station could only signal a single random access channel (RACH) configuration in a cell and hence single preamble format could be used (per BWP), the base station 5 in the system 1 is able to signal multiple different PRACH configurations having associated different PRACH preamble formats to the UE 3 in a single cell (per BWP). This allows any of the multiple different PRACH configurations and the associated PRACH preamble formats to be used by a given UE 3 and hence also allows different UEs 3 to use a different PRACH configurations and hence different PRACH preamble formats at the same time. The different PRACH preamble formats can be multiplexed.

Various apparatus that may be used for implementing the system 1 will now be described, by way of example only.

### User Equipment

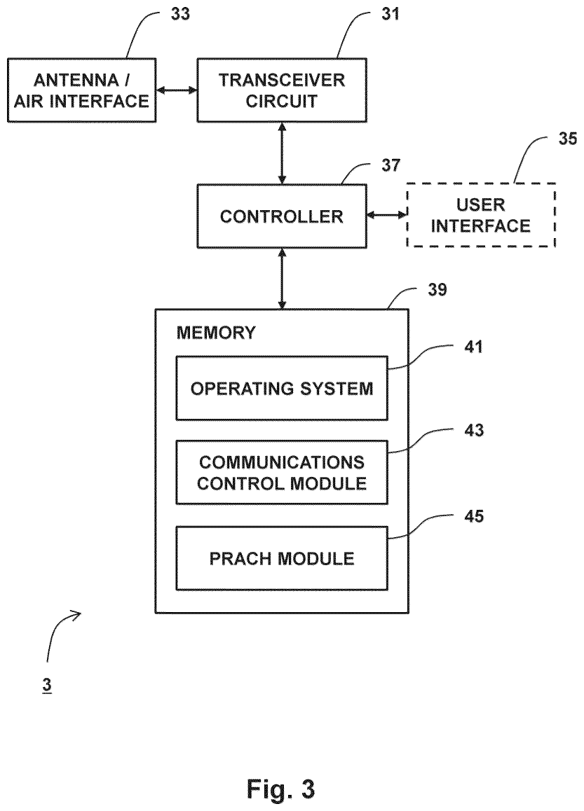

FIG. 3 is a simplified block schematic illustrating the main components of a UE 3 for implementation in the system shown in FIGS. 1, and 2A to 2C.

As shown, the UE 3 comprises transceiver circuitry 31 that is operable to transmit signals to and to receive signals from a base station 5 via an air interface 33 and one or more antennas (e.g. indirectly via a non-terrestrial platform 11 and possibly gateway 9 where applicable or directly in a wholly terrestrial scenario).

The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software and firmware, as appropriate.

The controller 37 is configured to control overall operation of the UE 3 by, in this example, program instructions or software instructions stored within the memory 39. The software may be pre-installed in the memory 39 and/or may be downloaded via the telecommunications network or from a removable data storage device (RMD), for example. As shown, these software instructions include, among other things, an operating system 41, a communications control module 43, and a PRACH module 45.

The communications control module 43 is operable to control the communication between the UE 3 and the base station 5. For example, the communications control module 43 controls the part played by the UE 3 in the flow of uplink and downlink user traffic and of control data to be transmitted from the base station 5 including, for example, control data for managing operation of the UE 3. The communication control module 43 is responsible, for example, for controlling the part played by the UE 3 in procedures such as the reception of measurement control/configuration information, reception of system information, handover procedures, implementing appropriate timing advances to compensate for timing misalignments etc.

The PRACH module 45 manages the performance of PRACH procedures such as the contention-based or contention free random-access procedures at the UE side. This includes, for example: identifying available PRACH configurations from received system information; identifying appropriate preambles and/or cyclic shifts to use for RA procedures; the reception of signalling assigning a PRACH preamble to a UE (for contention free procedures); the transmission of random-access messages to the base station (e.g. Msg1 or MsgA carrying the preamble and/or Msg3); the processing and reception of random-access messages from the base station (e.g. random-access response messages (Msg2, Msg4, and/or MsgB); and/or the reception and transmission of any other PRACH related signalling.

### Access Network Node

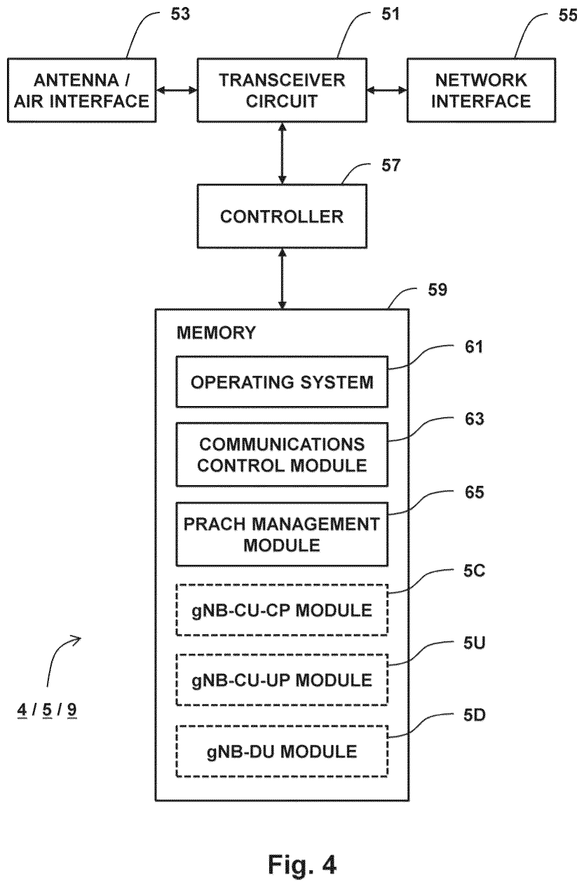

FIG. 4 is a block diagram illustrating the main components of a generic access network node such as a base station 5/gateway 9 shown in FIGS. 1, and 2A to 2C. This block diagram is also applicable to the NTN node 4. As shown, the access network node has a transceiver circuit 51 for transmitting signals to and for receiving signals from user equipment (such as the mobile device 3) via an air interface (one or more antenna) 53, and a network interface 55 for transmitting signals to and for receiving signals from the core network 7 and base stations. In case of the NTN node, the network interface 55 is part of the air interface 53. The access network node has a controller 57 to control the operation of the access network node in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and a PRACH management module 65. Although not shown in FIG. 4, the network interface 55 will also typically include a base station to base station interface portion (e.g. Xn), and a core network interface portion (e.g. NG-C/NG-U).

The communications control module 63 is responsible for handling (generating/sending/receiving) signalling between the access network node and other nodes, such as the UE 3, base stations, and the core network nodes. Such signalling may include, for example, control data for managing operation of the mobile device 3 (e.g. NAS, RRC, paging, system information, and/or the like). It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The communications control module 63 is operable to control the communication between the access network node and the UEs 3 and between the access network node and other network entities that are connected to the access network node. For example, the communications control module 63 controls the part played by the access network node in the flow of uplink and downlink user traffic and of control data to be transmitted to the UE(s) 3 served by the access network node including, for example, control data for managing operation of the UEs 3. The communication control module 63 is responsible, for example, for controlling the part played by the access network node (base station) in procedures such as the communication of measurement control/configuration information, the broadcast of system information, handover procedures, determining and signalling appropriate timing advances to compensate for timing misalignments etc.

The PRACH management module 65 manages the configuration of the various different PRACH configurations for different types of UEs and for generating the corresponding configuration information for configuring those PRACH configurations (e.g. for provision in system information communicated under the overall control of the communication control module 63). The PRACH management module 65 also manages the performance of PRACH procedures such as the contention-based or contention free random-access procedures at the base station side. This includes, for example: the assignment and signalling of a PRACH preamble to a UE (for contention free procedures); the reception and processing of random-access messages from the UE (e.g. Msg1 or MsgA carrying the preamble and/or Msg3); the transmission of random-access messages to the UE (e.g. random-access response messages (Msg2, Msg4, and/or MsgB); and/or for managing the reception and transmission of any other PRACH related signalling.

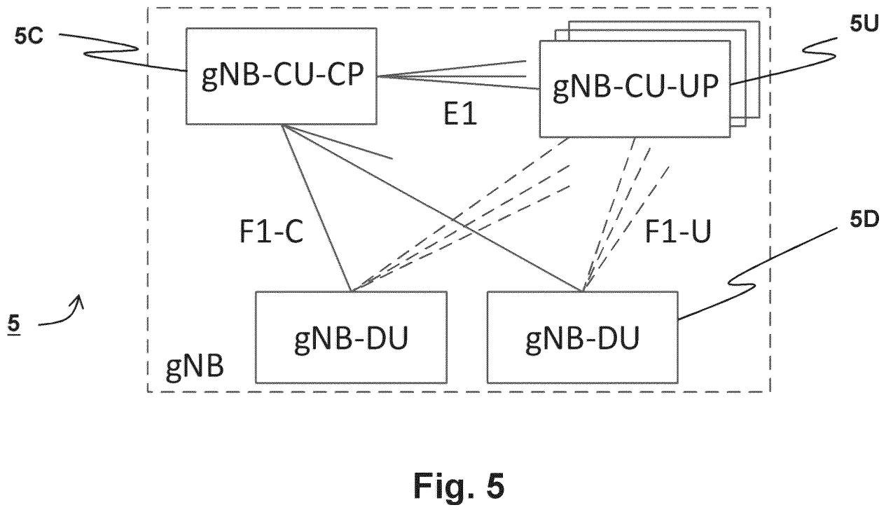

When the access network node comprises a distributed base station (distributed gNB or en-gNB), as shown in FIG. 5, the network interface 55 also includes an E1 interface and an F1 interface (F1-C for the control plane and F1-U for the user plane) to communicate signals between respective functions of the distributed base station. In this case, the software also includes at least one of: a gNB-CU-CP module 5C, a gNB-CU-UP module 5U, or a gNB-DU module 5D. If present, the gNB-CU-CP module 5C hosts the RRC layer and the control plane part of the PDCP layer of the distributed gNB or en-gNB. If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed gNB or en-gNB.

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

### DETAILED DESCRIPTION

Various methods that may be used in the system 1 will now be described, by way of example only.

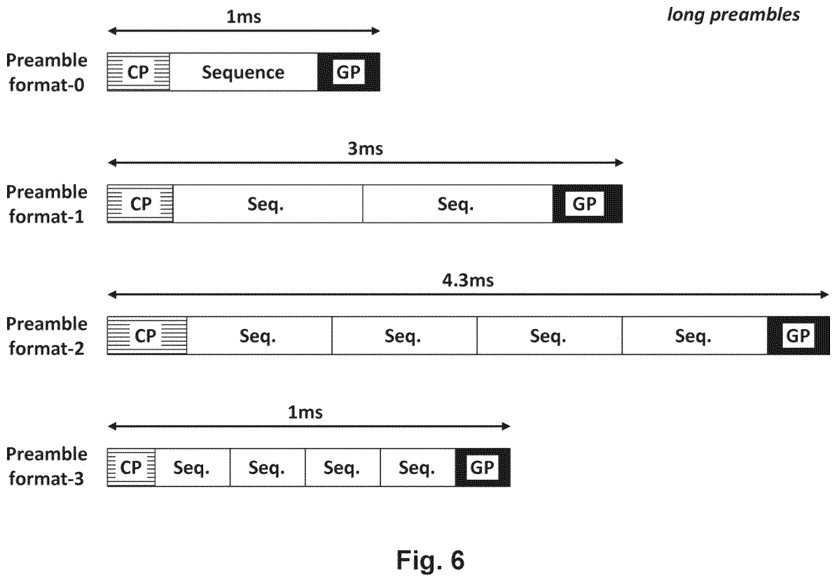

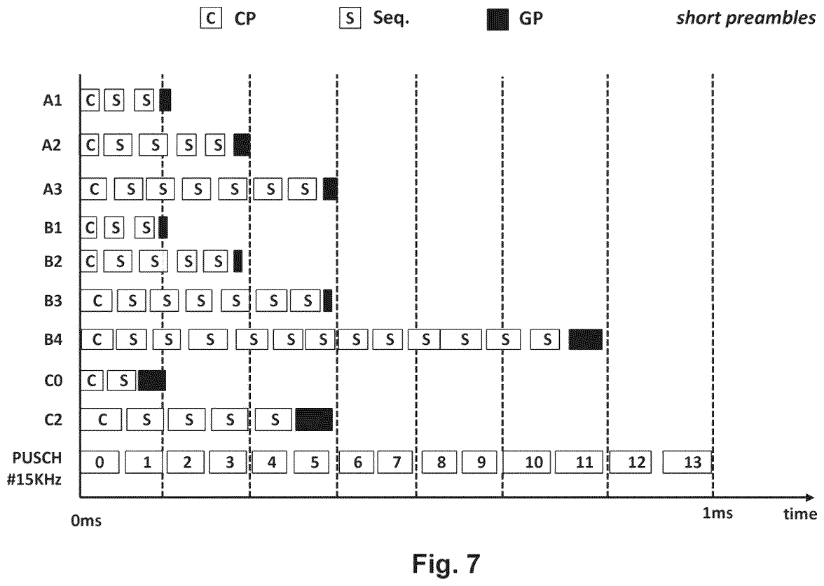

FIGS. 6 and 7 illustrate the preamble formats for long and short preambles, respectively. As can be seen, each preamble format has a different respective CP+Sequence+GP set. PRACH preamble formats 0 through 3 are referred to as long preambles and the PRACH preamble formats A1 to A3, B1 to B3, CO and C2 are referred to as short preambles. It will be appreciated that by increasing the number of RACH sequence repetitions better UL coverage may be achieved as the base station 5 combines transmission from multiple RACH sequences (at the expense of overall available UL resources).

The different preamble sequences that can be used for the preambles are typically based on Constant Amplitude Zero Auto Correlation (CAZAC) sequences such as Zadoff-Chu sequences. The CAZAC sequence on which the preambles are based has a sequence length, L, in number of samples that is a prime number (839 for long preambles and 139 for short preambles) corresponding to as many orthogonal codes. For such prime-length sequences there are, therefore, L−1 (838 for long preambles and 138 for short preambles) different possible near orthogonal root sequences having low correlation (1/√839 for long sequences) between them that can be generated, each corresponding to a unique root index.

Different preamble sequences that are inherently orthogonal to one another can also be generated from different cyclic shifts of the same root index. However, this orthogonality is conditional on the cyclic shift between the different sequences being larger than the difference between the respective timings at which they are transmitted. Any such UL timing misalignment will effectively cause a shift in the cycle (e.g. the UE sends sequence 100 but the base station interprets this as sequence 102 or 118). Accordingly, in some cases, only a reduced subset of possible cyclic shifts can be used to generate different preambles in dependency on the timing uncertainty (and hence cell size). Where all practically possible preamble sequences for a given root index become fully utilised, a different preamble sequence may need to be generated using a different root index.

The use of cyclic shifting allows preambles derived from a given root sequence to be divided between 1 to 64 groups (corresponding to the preamble signature) with the number of possible cyclic shifts depending on the maximum expected delay i.e. the cell radius as illustrated in Table 1 below:

TABLE 1

| Sequence | # of cyclic | | Cyclic | Max cell radius |
|---|---|---|---|---|
| length | shifts per | # of ZC | shift | from cyclic |
| (μs) | ZC seq. | sequences | (samples) | shift (km) |
| 800 | 64 | 1 | 13 | 0.78 |
| | 32 | 2 | 26 | 2.59 |
| | 16 | 4 | 53 | 6.34 |
| | 8 | 8 | 107 | 13.85 |

By way of example, considering the fourth row of Table 1, it can be seen that if preamble sequences derived from a given root index are fully utilised (e.g. divided into 8 for a cell of radius, r, where 6.34 km<r<13.85 km), then 7 other root indexes with low correlation must be used to achieve 64 preamble sequences.

UEs with no timing misalignment could, theoretically, use 839 preambles per sequence without the need for other root indexes to be used. This could be achieved when, for example: a UE has a recently stored timing advance (TA) value; a UE is at the cell centre (hence transmitting with no UL delay); or a UE has positioning capabilities and knowledge of base station location and can therefore calculate a TA value in advance and to apply it to compensate for the misalignment that would otherwise occur (this is referred to as pre-compensation).

The concept of zero-correlation zones (ZCZs) are used to account for the maximum expected delay/shift between one accepted sequence and the next. The base station can estimate the timing advance (TA) required for the TA command from this shift. The set of cyclic shifts that can be used within a cell are configured by the base station by means of a so-called zero-correlation zone parameter forming part of a random-access configuration provided by the base station in system information (e.g. in system information block type 1 (SIB1)).

The 838 root indexes are divided between neighbouring cells and may thus run out, ultimately limiting the number of available preambles in a given time/frequency resource.

The current theoretical cell size limitation is approximately a 100 km radius to allow for the maximum timing misalignment caused by UL delay for UEs at the cell edge (to a sequence length of 0.8 ms and maximum GP of 0.93 ms—i.e. preamble format 2 in FIG. 6—corresponds to the ultimate limitation). However, significantly bigger cells are expected in NTN (up to 1000 km radius) that may lead to higher differences in UL delay for different UEs' preambles on the RACH, depending on the altitude of the satellite and the maximum angle between the satellite and the cell centre.

The size of the cells negatively impacts random-access resources in multiple ways and this impact scales worse than quadratically with cell radius. Specifically, the number of UEs in a cell scales with the square of the radius (quadratic scaling). Preamble formats with a longer GP results in longer preamble sequences and thus fewer preambles per resource (linear scaling). Moreover, a long ZCZ can lead to poor sequence utilization (typically one signature per root) which could lead to more interference between preambles because different root sequences are not perfectly orthogonal. Poor sequence utilisation also leads to root sequence overutilization leading to a progressive deterioration with cell size and representing a fundamental physical limitation.

In order to avoid the UL misalignment and preamble format issues that would result with providing NR over NTN, a UE is currently required to at least support UE specific TA calculation for pre-compensation based at least on a Global Navigation Satellite System (GNSS)-acquired position and knowledge of the serving satellite ephemeris. However, such a capability TA pre-compensation may not be sufficient, and support for UEs without GNSS capability is not precluded for future releases of the standards.

The PRACH transmission power is determined based on maximum UE transmission power, observed path loss, and power ramping procedure. Note that for satellite communication (for large payload to UE distance), the required power to transmit PRACH can be significantly high due to the high associated path loss.

In more detail, 3GPP TS 38.213 V17.1.0, section 7.4 specifies that a UE determines a transmission power for a physical random-access channel (PRACH), P_{PRACH, b,f,c}(i), on active UL BWP b of carrier f of serving cell C based on DL RS for serving cell @ in transmission occasion i as

$${P}_{PRACH , b , f , c} ( i ) = min \{ {P}_{CMAX , f , c} ( i ) , {P}_{PRACH , target , f , c} + {PL}_{b , f , c} \} [ dB m ] ,$$

where P_{CMAX,f,c}(i) is the UE configured maximum output power defined in 3GPP TS 38.101-1, TS 38.101-2, and TS 38.101-3 for carrier f of serving cell C within transmission occasion i, P_{PRACH, target, f,c} is the PRACH target reception power PREAMBLE_RECEIVED_TARGET_POWER provided by higher layers for the active UL BWP b of carrier f of serving cell C and PI_{b,f,c} is a pathloss for the active UL BWP b of carrier f based on the DL RS associated with the PRACH transmission on the active DL BWP of serving cell C and calculated by the UB in dB as referenceSignalPower—higher layer filtered RSRP in dBm.

The different power classes of UEs 3 are based on their maximum transmission power capability, as summarized in Table 2.

TABLE 2

| NR | Class 1 | Tolerance | Class 2 | Tolerance | Class 3 | Tolerance |
|---|---|---|---|---|---|---|
| band | (dBm) | (dB) | (dBm) | (dB) | (dBm) | (dB) |
| n1 | | | | | 23 | ±2 |
| n2 | | | | | 23 | ±2³ |
| n3 | | | | | 23 | ±2³ |
| n5 | | | | | 23 | ±2 |
| n7 | | | | | 23 | ±2³ |
| n8 | | | | | 23 | ±2³ |
| n12 | | | | | 23 | ±2³ |
| n14 | 31 | +2/−3 | | | 23 | ±2³ |
| n18 | | | | | 23 | ±2 |
| n20 | | | | | 23 | ±2³ |
| n25 | | | | | 23 | ±2³ |
| n26 | | | | | 23 | ±2³ |
| n28 | | | | | 23 | +2/−2.5 |
| n30 | | | | | 23 | ±2 |
| n34 | | | | | 23 | ±2 |
| n38 | | | | | 23 | ±2 |
| n39 | | | | | 23 | ±2 |
| n40 | | | | | 23 | ±2 |
| n41 | | | 26 | +2/−3³ | 23 | ±2³ |

Further, 3GPP TS 38.101-1 V17.5.0, section 6.2.4 specifies that the UE is allowed to set its configured maximum output power P_{CMAX,f,c} for carrier f of serving cell c in each slot. The configured maximum output power P_{CMAX,f,c} is set within the following bounds:

$${P}_{CMAX \_ L , f , c} \leq {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MRP}_{c} ) \}$$

$${P}_{CMAX \_ H , f , c} = MIN \{ {P}_{EMAX , c} , {P}_{PowerClass} - Δ {P}_{PowerClass} \}$$

Effectively, it means that for each slot the maximum transmission power can vary with a certain margin based on UE implementation.

The relevant 3GPP standard (TS 38.331 V17.0.0) defines that the preamble formats are broadcast using various information elements in SIB1 to provide the relevant RACH parameters (or information elements), such as:
RACH-ConfigCommon: this information element is used to specify the cell specific random-access parameters. It includes, amongst others, the RACH-ConfigGeneric field and the prach-RootSequenceIndex-r16 field.
RACH-ConfigGeneric: this information element is used to specify the random-access parameters both for regular random access as well as for beam failure recovery. It includes, amongst others, the prach-ConfigurationIndex field that provides format, location, and periodicity of random-access resources.

However, in accordance with the current 3GPP specifications, only one preamble format can be broadcast per cell, at any one time, for initial acquisition.

Some of the fields that may be included in the RACH-ConfigCommon information element are summarised below:

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) [...] |

ssb-perRACH-OccasionAndCB-PreamblesPerSSB CHOICE {

| | |
|---|---|
| oneEighth | ENUMERATED {n4, [...] n64}, |
| oneFourth | ENUMERATED {n4, [...] n64}, |
| oneHalf | ENUMERATED {n4, [...] n64}, |
| one | ENUMERATED {n4, [...] n64}, |
| two | ENUMERATED {n4, [...] n32}, |
| four | INTEGER (1..16), |
| eight | INTEGER (1..8), |
| sixteen | INTEGER (1..4) |
| } | |
| [...] | |

Some of the fields that may be included in the RACH-ConfigGeneric information element are summarised below:

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |

msg1-FrequencyStart INTEGER (0..maxNrofPhysicalResourceBlocks−1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, |
| | n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, |
| | sl10, sl20, sl40, sl80}, |
| [...] | |

Commercial UEs (e.g. smartphones) are power limited and they require RACH enhancements (e.g. more repetitions). On the other hand, VSAT devices have higher power capability and hence do not require coverage enhancement solutions.

In order to support both commercial smartphones and VSAT devices to access NTN cells, whilst also minimising random-access failures, this system 1 employs multiple RACH formats which are multiplexed together per cell to cater to the need of different UE types/power classes.

Beneficially, this approach allows avoiding (or reducing the need for) configuring a large portion of RACH resources (or all RACH resources) for enhanced coverage (e.g. higher repetitions) which would be wasteful of scarce UL resources when the density of commercial UEs connecting to NTN (due to service continuity) is low as compared to VSAT UEs.

As explained above, whilst NR supports different PRACH formats which have different repetitions patterns, the current specification only allow a single RACH format per cell.

However, for NTN or other large cell scenarios, it may be beneficial to support multiple PRACH formats per cell and allow the UE 3 to select one PRACH format based on conditions specified in the following.

This approach would result in a better resource utilization (e.g. based on fraction of the UEs that are power limited, the network can decide whether to use one or more PRACH format(s) with a higher number of repetitions).

Although the present disclosure describes the case of multiplexing two RACH formats, it will be appreciated that the same approach can be applied to support multiplexing of three or more RACH formats.

The following is a description of the relevant details of signalling to realise RACH format multiplexing, and some possible RACH resource selection criteria based on UE transmission power.

### Option 1

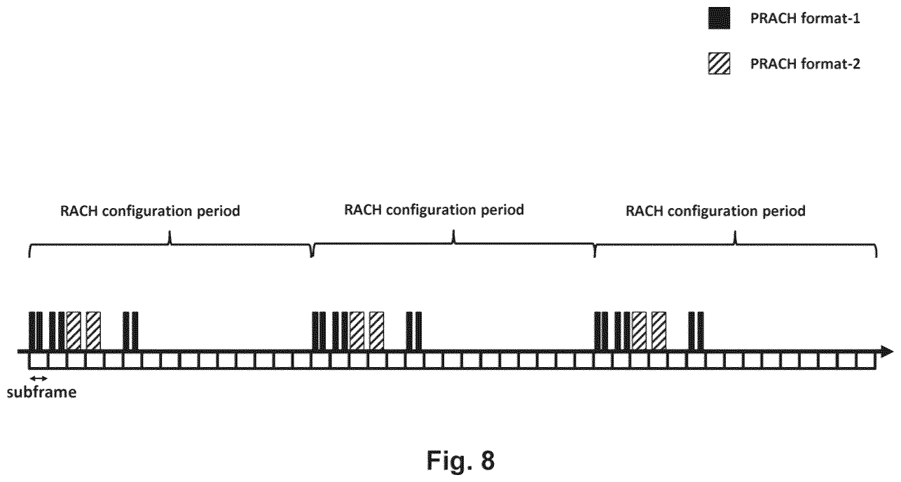

FIG. 8 illustrates an exemplary approach to implement two or more PRACH preamble formats in a cell (e.g. per UE type/power class/maximum power).

In this case, a single entry of the PRACH configuration table indicates time occasions for each PRACH formats that may be multiplexed together. In the example shown in FIG. 8, frequency resources are shared between two preamble formats but time occasions are different. In more detail, the prach-ConfigurationIndex field of the RACH-ConfigGeneric information element is set to an appropriate value that is associated with a specific set of two or more PRACH preamble formats, each format being associated with a respective resource (in time/frequency domain). Each format may also be associated with a particular UE power class/maximum power value or a UE type (e.g. VSAT UE or commercial UE).

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |

msg1-FrequencyStart INTEGER (0..maxNrofPhysicalResourceBlocks−1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, |
| | n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, |
| | sl10, sl20, sl40, sl80}, |
| [...] | |

In this case, the ‘Preamble format’ column of Table 3 may be adapted to include (at least for some values of the PRACH configuration index) a plurality of preamble formats (at least two preamble formats). Another column may be added to indicate the associated UE type/power class/maximum power value (if appropriate). However, it will be appreciated that the associated UE type/power class/maximum power (per preamble format or sets of preamble formats) may be indicated using system information and/or the like.

TABLE 3

| | | | | | | | N [symbol] | |
|---|---|---|---|---|---|---|---|---|
| | | | | | | | number of | |
| | | | | | | | time- | |
| | | | | | | Number | domain | |
| | | | | | | of | PRACH | |
| | | | | | | PRACH | occasions | |
| PRACH | | | | | | slots | within a | N [symbol] |
| Configuration | Preamble | n [symbol] mod x [symbol] y | | Subframe | Starting | within a | PRACH | PRACH |
| Index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |

[symbol]

indicates data missing or illegible when filed

This approach is illustrated in FIG. 8, which uses two different PRACH preamble formats as an example. As can be seen, in each RACH configuration period for which the random-access configuration (RACH-ConfigGeneric information element) is applicable, the different PRACH preamble formats are allocated to the different resources (in this case different time domain resources, such as different subframes/slots/symbols). Thus, each UE 3 in the cell is able to transmit a random-access preamble using the appropriate PRACH preamble format, over respectively allocated resources and thereby avoid causing interference to other UEs 3 (of different type of power class).

For a particular PRACH configuration period, the entry (the PRACH configuration index) may indicate the subframes and/or slots corresponding to each PRACH format. In this case, the following cases are envisaged:
Each subframe contains a single PRACH format type and the entry indicates which subframe is mapped to which PRACH format type.
Each slot contains a single PRACH format type and the entry indicates which slot is mapped to which PRACH format type. For example, slots 3, 6, 7, 8 may be for PRACH format-1 and the remaining slots for PRACH format-2. Alternatively, even slots of each subframe may be allocated to PRACH format-1 and odd slots to PRACH format-2.
Within each slot, multiple PRACH formats can be supported. In this case the entry indicates which symbols/occasions of the slot are used for each PRACH format type.

It will be appreciated that it may not be possible to define a new PRACH configuration table, as described above. In order to ensure backward compatibility with legacy UEs, a new RACH configuration index may be defined that includes all the RACH occasions corresponding to legacy RACH configuration table indices. On top of the RACH occasions already present, new RACH occasions corresponding to different RACH format(s) may be added for UEs that support the multiple PRACH preamble format design (which may be specified in a new version of the standards).

An example is given in Table 4 below, where entry #94 allocates preamble format A1 to legacy UEs and allocates preamble format A3 to newer UEs.

TABLE 4

| | | | | | | | N [symbol] | |
|---|---|---|---|---|---|---|---|---|
| | | | | | | | number of | |
| | | | | | | | time- | |
| | | | | | | Number | domain | |
| | | | | | | of | PRACH | |
| | | | | | | PRACH | occasions | |
| PRACH | | | | | | slots | within a | N [symbol] |
| Configuration | Preamble | n [symbol] mod x [symbol] y | | | Starting | within a | PRACH | PRACH |
| Index | format | x | y | Subframe number | symbol | subframe | slot | duration |
| 94 | A1, A3 | 2 | 0 | A1: 4, 9 (Legacy ROs) | 0 | 1 | 6 | 2 |
| | | | | A3: 1, 5 (New ROs) | 0 | 1 | 2 | 6 |

[symbol]

indicates data missing or illegible when filed

This approach may be particularly beneficial for technologies other than NR (e.g. 6G and beyond) where backward compatibility issues are less likely to arise.

To handle transmission power requirements corresponding to different RACH formats, an offset and/or a power value may be provided for the preamble received target power per RACH format to account for the fact that different receiving powers are required for multiplexed RACH formats due to different RACH sequence repetition numbers of the formats.

This offset or power value may be a configured value or an offset fixed in specification (e.g. per PRACH configuration index) or may be derived based on the number of repetitions of the PRACH sequence of a PRACH format (e.g. a larger offset may be used for a larger number of sequence repetitions).

Other RACH parameters such as root sequence index, number of RACH preambles may be common to each RACH format. Since most of the parameters will be common between the formats, it is suitable to multiplex RACH sequences corresponding to same PRACH sequence length (LRA).

RACH format/occasion selection for subsequent RACH attempts may be realised using any of the following alternatives:
Alt-1: the same RACH format may be used for each RACH attempt of a random access procedure;
Alt-2: the UE is allowed to choose a different RACH format (if PRACH format selection criteria changes) but it needs to use the same power ramping counter as used in its last RACH attempt when RACH format changes between the attempts;
Alt-3: the UE is allowed to choose a different RACH format (if PRACH format selection criteria changes) and it increments the power ramping counter as usual;
Alt-4: the UE is allowed to choose a different RACH format only if the new PRACH format requires a lower transmission power than the current PRACH format;
Alt-5: the UE is allowed to choose a different RACH format only if the new PRACH format has a higher number of repetitions or a longer PRACH sequence than the current PRACH format (after observing N number of RACH failures, where the value of N can be configured for the UE).

### Option 2

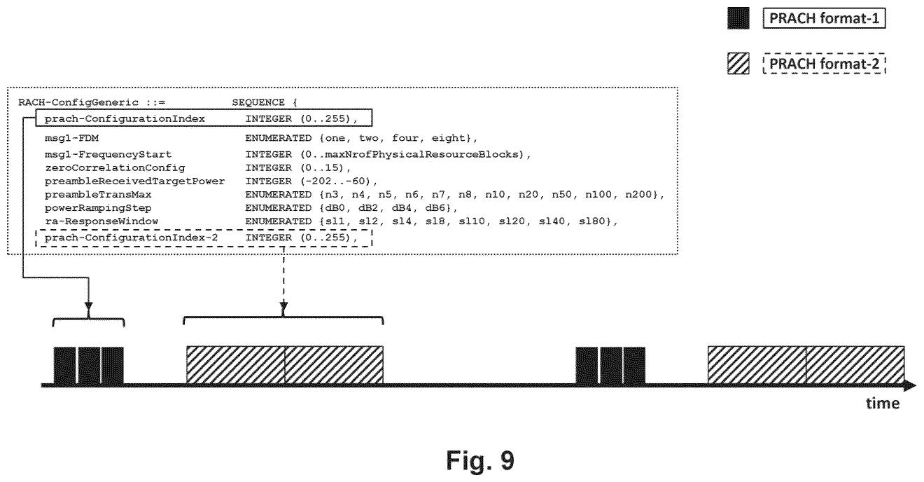

FIG. 9 illustrates another exemplary approach to implement two or more PRACH preamble formats in a cell (e.g. per UE type/power class/maximum power). In this case, multiple PRACH configuration indices are provided per cell with other RACH configuration parameters shared by the indices.

For example, multiple PRACH configuration indices may be provided using a single RACH-ConfigGeneric field of the RACH configuration:

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks), |
| zeroCorrelationZoneConfig | INTEGER (0..15), |
| preambleReceivedTargetPower | INTEGER (−202..−60), |
| preambleTransMax | ENUMERATED {n3, n4, n5, n6, n7, n8, |
| | n10, n20, n50, n100, n200}, |
| powerRampingStep | ENUMERATED {dB0, dB2, dB4, dB6}, |
| ra-ResponseWindow | ENUMERATED {sl1, sl2, sl4, sl8, |
| | sl10, sl20, sl40, sl80}, |
| prach-ConfigurationIndex-2 | INTEGER (0..255), |
| [...] | |

Alternatively, the respective PRACH configuration indices may be provided using separate RACH-ConfigCommon fields per RACH configuration.

Note that this approach may require additional consideration on how to time multiplexing of multiple PRACH configuration indices because there is a risk that RACH occasions corresponding to different RACH configuration indices are overlapping. In order to avoid overlapping RACH occasions, the network (base station 5) selects those RACH configuration indices to multiplex which do not have overlapping RACH occasions.

It will be appreciated that some of the parameters will be independently provided for the second PRACH configuration index, including but not limited to, for example:
Frequency offset (msg-1 FrequencyStart) and number of frequency domain PRACH resources (msg-1FDM) to perform frequency multiplexing between RACH formats;
Preamble received target power (preambleRceivedTargetPower) and power ramping step (powerRampingStep) can be independently set to account for different transmission power limits of different UEs;
Maximum number of RACH attempts (preambleTransMax) allowed can be independently set to account for different collision probabilities for the RACH occasions; and
zeroCorrelationZoneConfig and restrictedSetConfig can be provided independently to account for different correlation properties of different RACH sequences.

It will be appreciated that the alternatives for RACH format selection for subsequent RACH attempts may be the same as for Option 1 (see Alt-1 to Alt-5 listed above).

It will be appreciated that Synchronization Signal Block (SSB) to RACH mapping will be performed independently for each PRACH configuration index where RACH occasions are available. RACH occasions are independently counted for each PRACH configuration index.

A PDCCH order may be used to indicate the PRACH format to be used by the UE for initiating RACH. In other words, the UEs can select one of the plurality of the PRACH formats based on the PDCCH order.

### Option 3

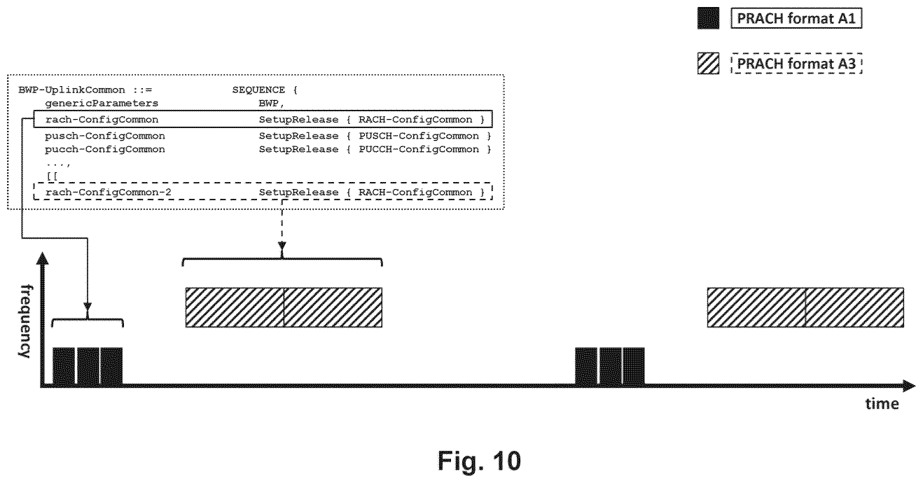

FIG. 10 illustrates another exemplary approach to implement two or more PRACH preamble formats in a cell (e.g. per UE type/power class/maximum power). In this case, the respective PRACH configuration indices are provided using separate RACH-ConfigCommon fields per RACH configuration, as illustrated in FIG. 10 (and below). This approach also makes it possible to allocate different frequency resources to different PRACH preamble formats (or different UE power classes/power levels).

| | |
|---|---|
| BWP-UplinkCommon ::= | SEQUENCE { |
| genericParameters | BWP, |
| rach-ConfigCommon | SetupRelease { RACH-ConfigCommon } |
| pusch-ConfigCommon | SetupRelease { PUSCH-ConfigCommon } |
| pucch-ConfigCommon | SetupRelease { PUCCH-ConfigCommon } |
| ..., | |
| [[ | |
| rach-ConfigCommon-2 | SetupRelease { RACH-ConfigCommon } |
| [...] | |

Using a respective (different) RACH configuration for each UE type/power class allows configuring all random-access parameters independently for each RACH preamble format. This approach allows greater flexibility in terms of RACH resource configuration but incurs relatively higher signalling overhead. Moreover, similarly to Option 2, time/frequency multiplexing of RACH configuration needs to be considered carefully.

In this case, RACH format selection for subsequent RACH attempts may be realised using one of the following alternatives:
Alt-1: the same RACH format may be used for each RACH attempt of a random access procedure because all parameters (e.g. power ramping) are set independently;
Alt-2: the UE may be allowed to change PRACH format between subsequent RACH attempts of a random-access procedure but the associated power ramping counter needs to be updated based on at least the configured power ramp step for the new RACH format and current power ramp power applied.

In case of Alt-2, the following formula may be used:

$$New Power ramping step = Current power ramp power / power ramp step of new PRACH format$$

### Option 4

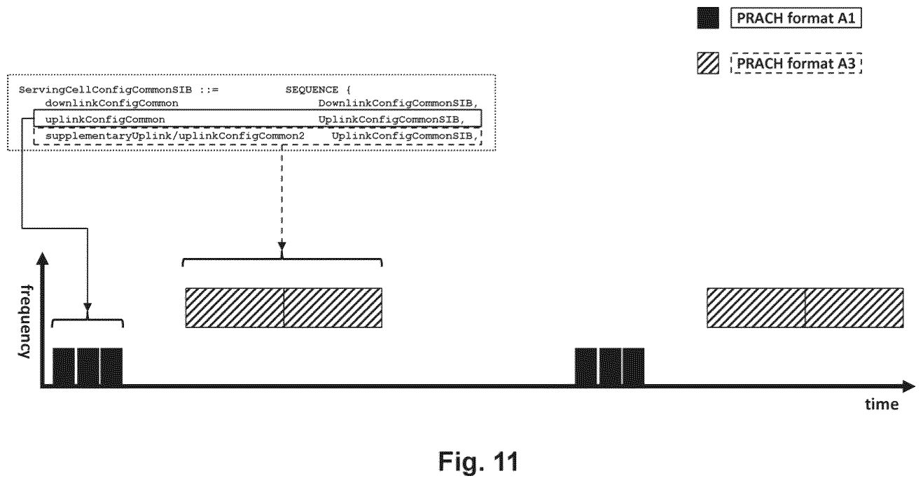

FIG. 11 illustrates another exemplary approach to implement two or more PRACH preamble formats via two or more cells. In this case, respective PRACH configuration indices (identifying respective preamble formats) are provided using separate uplinkConfigCommon information elements, as illustrated below. Effectively, each cell may be allocated to one or more UE type/power class/maximum transmit power value, and different UEs may be served via different cells.

For example, a first PRACH preamble format (with an associated PRACH configuration index) may be configured via a first uplink ConfigCommon information element and a second PRACH preamble format (with its associated PRACH configuration index) may be configured via a second uplinkConfigCommon information element (denoted ‘uplinkConfigCommon2’ below). It will be appreciated that the supplementary Uplink information element may be used for configuring the second PRACH preamble format, if appropriate.

| | |
|---|---|
| ServingCellConfigCommonSIB ::= | SEQUENCE { |
| downlinkConfigCommon | DownLinkConfigCommonSIB, |
| uplinkConfigCommon | UplinkConfigCommonSIB, |
| supplementaryUplink/uplinkConfigCommon2 | UplinkConfigCommonSIB |
| [...] | |

Using this scheme, the base station 5 is able to configure two uplink cells (one cell with a relatively smaller number of RACH repetitions/format and another cell with a relatively large number of RACH repetitions/format). Each uplink cell may be associated to UEs with a specific power class value or a maximum transmission power level. Thus, the criteria to select the correct uplink carrier may be based on UE power class or maximum UE transmission power level. The scheme may also be extended to use three or more cells, if appropriate, to support three or more UE power class or transmission power level.

The cells share SSB transmissions/remaining minimum system information (RMSI) similarly to the so-called supplementary uplink (SUL) feature. For example, the network may configure a supplementary uplink carrier and indicate that the supplementary uplink carrier is associated with a set of (at least one) UE power classes or UE maximum transmission power levels.

This solution is also applicable to RACH multiplexing for the presence of UE GNSS capability. Specifically, the UE may select one of the uplink carriers (and apply the associated RACH configuration) for performing random-access based on whether the UE's location is available or not.

### Coverage Enhancement Aspects

In order to support two-step random-access via cells employing one of the options described above, the following approach may be used.

For each RACH format/configuration, the network may provide at least a partial (or full) PUSCH configuration for transmitting MsgA. The parameters that may be specific to a particular PRACH preamble format/RACH configuration include one or more of:
the number of PUSCH repetitions;
the modulation and coding scheme (MCS) for the PUSCH transmission; and
frequency and time allocation of PUSCH occasions.

Alternatively, MsgA configuration may be applicable for only a single PRACH format (i.e. the two-step RACH is enabled for a single PRACH format). The applicable PRACH preamble format/RACH configuration may be predefined (e.g. in a relevant 3GPP specification) or may be configured to UE 3 by the base station 5.

A similar approach may be used in case of the four-step random-access as well. For example, the UE 3 may transmit, to the base station 5, a random-access preamble (Msg1) according to the RACH preamble format and/or over a resource associated with coverage enhancement, to initiate a random-access procedure. In response to the preamble transmission, the base station 5 identifies a PUSCH resource with coverage enhancement to be used by the UE 3 for transmitting the third message (Msg3) of the four-step random-access procedure.

If the UE 3 selects a coverage enhanced (e.g. more repetitions) PRACH resource (or uses a PRACH format corresponding to coverage enhanced resources) then the network can provide PUSCH resources for Msg3 corresponding to a relatively higher number of repetitions.

It will be appreciated that the number of repetitions for PUSCH corresponding to coverage enhanced PRACH resources may be either configured via system information or provided by the network explicitly e.g. via a downlink control information (DCI) for the PUSCH.

To support UEs that require coverage enhancement, RACH resource selection/repetition selection may be realised based on UE power class/maximum UE transmit power. The network provides appropriate configuration information on which RACH resource/format to use.

For example, for each power class/max transmission power level, the network may configure a signal strength threshold indicating that if a reference signal received power (RSRP) (e.g. RSRP of SSB) is less than the threshold for the given power class/maximum transmission power level, then the UE should use an enhanced coverage RACH resource to transmit a preamble (Msg1/MsgA).

It is also possible to use path loss instead of RSRP. In this case, if the associated path loss determined by the UE is greater than a threshold then the UE uses an enhanced coverage RACH resource.

In case the instantaneous UE power level is low (e.g. for in device coexistence reasons) and the base station is unable to decode the UE's random-access transmission, then the UE may be configured to wait until its available transmission power is sufficient for RACH decoding at the base station.

Alternatively, RACH resource selection/repetition selection may be realised based on power difference of the instantaneous Pmax and the power required for successful reception at the base station.

For example, the network may configure RACH resources for different repetitions. If the required transmit power >Pmax+Offset, then the UE will use a PRACH resource with higher number of repetitions (if available). In this case, the Offset may be UE implementation specific, it may be fixed in the relevant 3GPP specification, or may be configured to the UE via system information.

It will be appreciated that this check may be required for each RACH attempt during an ongoing RACH (due to power ramp).

### Base Station Procedures

The following is a description of some ways in which the base station may select appropriate RACH formats to multiplex within a cell. It will be appreciated that, based on logged event reporting by the UE, the network is able determine how many UEs in coverage are not able to connect to the cell (NTN or non-NTN cell) due to low PRACH power. The network (base station) may be able to do so, based on one or more of the following:
indication from the UE regarding instances where random access procedure failed for connection establishment to cell (e.g. at least one instance);
indication from the UE regarding instances where random access procedure/connection establishment procedure was aborted due to lower UE transmission power (e.g. at least one instance); and
indication from the UE regarding instances where the UE failed to camp on a cell (e.g. at least one instance).

For each such event, the UE may also indicate one or more of the following:
average power difference between required PRACH transmission power computed by the UE and the maximum transmission power during random access procedure;
cell identity information;
location related information (e.g. GNSS/GPS coordinates or downlink beam identification e.g. SSB index);
for earth moving cells, it would also be beneficial to include time of event occurrence based on which the network can determine the satellite position and coverage at the given time; and
RACH format type configured in the associated RACH resources.

Using the above information and power class information of the UE (provided in separate capability signaling), the network can determine whether to configure any additional PRACH format (at least for some UEs/UE types) and which format to use.

Signalling multiple PRACH Configurations There are various ways in which the multiple PRACH configurations may be signalled by the base station 5 to the UE(s) 3 in a cell operated by the base station 5 (e.g. a cell of an NTN).

It will be appreciated that the different PRACH configurations will be typically provided in a system information broadcast (SIB1). Specifically, the different PRACH configurations can be provided using information elements (IEs) of an initialUplinkBWP IE/BWP-Uplink Common IE, of an uplinkConfigCommon IE/UplinkConfigCommonSIB IE, of servingCellConfigCommon IE/ServingCellConfigCommonSIB IE of SIB1.

SIB1 contains information relevant when evaluating if a UE is allowed to access a cell and defines the scheduling of other system information. It also contains radio resource configuration information that is common for all UEs and barring information applied to the unified access control.

The IE ServingCellConfigCommonSIB is used to configure cell specific parameters of a UE's serving cell in SIB1. The IE

Uplink ConfigCommonSIB provides common uplink parameters of a cell. The IE BWP-Uplink Common is used to configure the common parameters of an uplink BWP. They are “cell specific” and the network ensures the necessary alignment with corresponding parameters of other UEs. The common parameters of the initial bandwidth part of a primary cell are also provided via system information. For all other serving cells, the network provides the common parameters via dedicated signalling.

The IE RACH-ConfigCommon is used to specify the cell specific random-access parameters for a given PRACH configuration. This IE includes, among other IEs, the RACH-ConfigGeneric IE and the prach-RootSequenceIndex-r16 IE. The IE RACH-ConfigGeneric is used to specify the random-access parameters both for regular random access as well as for beam failure recovery. The IE prach-RootSequenceIndex-r16 provides the PRACH root sequence index and has a value in the range 0 . . . 837 or 0 . . . 137 depending on whether the length of the sequence is 839 or 139.

The IE RACH-ConfigGeneric includes, among other IEs: the prach-ConfigurationIndex IE that indicates the location and periodicity of RA resources; the ra-ResponseWindow IE that indicates the Msg2 (RAR) window length in number of slots and that will differ depending on UL TA misalignment; and the zeroCorrelationZoneConfig 1E that provides the cyclic shift configuration.

In one option, a respective RACH-ConfigCommon IE is included in SIB1 for each PRACH configuration. For example, each RACH-ConfigCommon IE contains a version of at least the relevant IEs for defining a respective PRACH configurations (e.g. a respective RACH-ConfigGeneric IE for each PRACH configuration).

In another option, a single RACH-ConfigCommon IE is included in SIB1 but a respective instance of every relevant IE is included in the single RACH-ConfigCommon IE for each PRACH configuration. For example, the single RACH-ConfigCommon IE contains a respective version of at least the relevant IEs for defining each PRACH configuration (e.g. a respective RACH-ConfigGeneric IE for each PRACH configuration).

In yet another option, a single RACH-ConfigCommon IE and a single RACH-ConfigGeneric IE is included in SIB1 but a respective instance of every relevant IE for each PRACH configuration is also included in the single RACH-ConfigCommon IE and the single RACH-ConfigGeneric IE as appropriate for each PRACH configuration. For example, the single RACH-ConfigCommon IE contains, in addition to the single RACH-ConfigGeneric IE, a respective version of at least the relevant RACH-ConfigCommon IEs (for each PRACH configuration). The single RACH-ConfigGeneric IE contained by the single RACH-ConfigCommon IE includes a respective version of at least the relevant RACH-ConfigGeneric IEs for defining each PRACH configuration (e.g. a respective prach-ConfigurationIndex IE for each PRACH configuration).

### Modifications and Alternatives

A detailed example embodiment has been described above. As those skilled in the art will appreciate, a number of modifications and alternatives can be made to the above example embodiments whilst still benefiting from the present disclosure embodied therein.

It will be appreciated that description of features of and actions performed by a base station (or gNB), NTN nodes, and UEs may be applied equally to base stations and UEs that communicate in the terrestrial plane only (i.e. as part of a terrestrial RAN without features of an NTN RAN such as a gateway and space or airborne platform) as to base stations that communicate via a non-terrestrial plane.

Moreover, description of features of and actions performed by a base station (or gNB) apply equally to distributed type base stations as to non-distributed type base stations.

The provision of multiple PRACH configurations is also applicable for massive machine-type-communication (mMTC) scenarios (e.g. sensors with high UE density in large cells (both terrestrial and non-terrestrial cells) requiring RACH for small UL transmissions from IDLE/INACTIVE), which are particularly demanding on the RACH.

It will also be appreciated that whilst information elements having specific names have been described differently named information elements but having a similar purpose may be used.

TABLE 5
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the | 100-1000 | km |
| (LEO) satellite | | | earth | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms | | |
| UAS platform | 8-50 km | | of elevation/azimuth | 5-200 | km |
| (including HAPS) | (20 km for HAPS) | | with respect to a given | | |
| | | | earth point | | |
| High Elliptical Orbit | 400-50000 | km | Elliptical around the | 200-3500 | km |

| | |
|---|---|
| (HEO) satellite | earth |

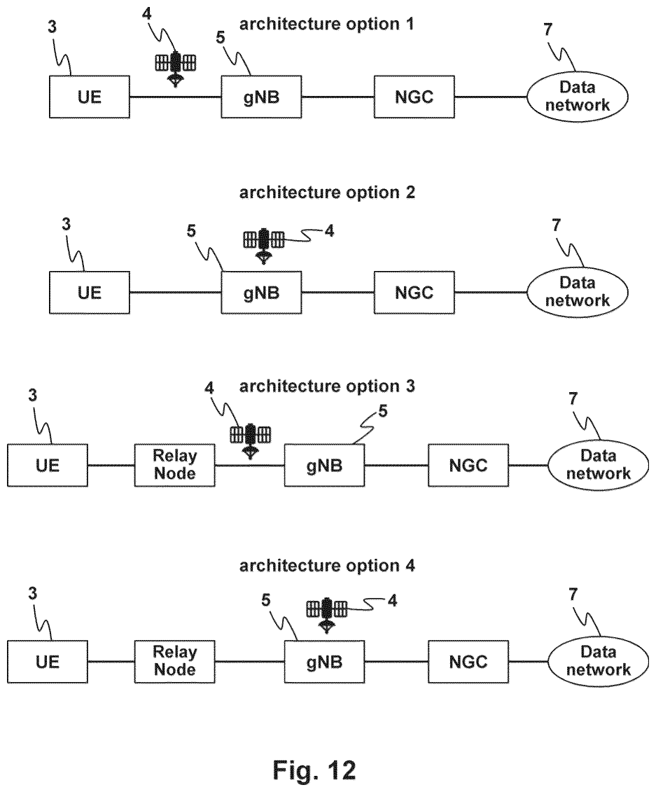

It will be appreciated that there are various architecture options to implement NTN in a 5G/NR system, some of which are illustrated schematically in FIG. 12. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS. It will be appreciated that similar architecture options may be used in a 4G/E-UTRA system as well, but with eNB instead of gNB, and EPC instead of NGC.

In the above description, the UE, the NTN node (satellite/UAS platform), and the access network node (base station) are described for ease of understanding as having a number of discrete functional components or modules. Whilst these modules may be provided in this way for certain applications, for example where an existing system has been modified to implement the present disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the UE, to the NTN node (satellite/UAS platform), or to the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node (satellite/UAS platform), or the access network node (base station) in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; moulds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Further, the above-described UE categories are merely examples of applications of the technical ideas and exemplary example embodiments described in the present document. Needless to say, these technical ideas and example embodiments are not limited to the above-described UE and various modifications can be made thereto.

Each feature disclosed in this specification (which term includes the claims) and/or shown in the drawings may be incorporated in the present disclosure independently of (or in combination with) any other disclosed and/or illustrated features where it is technically feasible to do so. In particular but without limitation the features of any of the claims dependent from a particular independent claim may be introduced into that independent claim in any combination or individually wherever doing so does not cause a technically incompatibility or result in something that does not make technical sense.

Each PRACH preamble format may be associated with a respective UE uplink transmission power and/or UE power class.

The random-access configuration information may indicate association between one or more of respective resources in a time domain within the period and the plurality of the PRACH preamble formats. The at least two of the plurality of the PRACH preamble formats may be associated with the same frequency.

The random-access configuration information may identify, for each PRACH preamble format, a respective preamble received target power.

The preamble received target power may be identified by at least one of an offset or a power value.

The method performed by the UE may further comprise: transmitting, to the access network node, signalling for initiating a random-access procedure, the signalling comprising a random-access preamble having one of the plurality of the PRACH formats; and communicating with the access network node for completing the random-access procedure.

The method performed by the UE may further comprise selecting the one of the plurality of the PRACH formats based on at least one of a power class associated with the UE or a maximum transmission power supported by the UE.

The method performed by the UE may further comprise selecting the one of the plurality of the PRACH formats based on a physical downlink control channel (PDCCH) order.

The random-access configuration information may identify, for a cell, at least one entry of a PRACH configuration table, each of the at least one entry of a PRACH configuration table being associated with different one of the plurality of the PRACH preamble formats.

The random-access configuration information may identify at least one common parameter for the at least one entry.

For example, the random-access configuration information may identify, for the at least one entry, one or more of the following:
an associated frequency offset and a number of frequency domain PRACH resources to perform frequency multiplexing of the PRACH preamble formats;
an associated preamble received target power;
an associated power ramping step;
an associated maximum number of random-access attempts;
an associated value for a zeroCorrelationZoneConfig information element; and
an associated value for a restrictedSetConfig information element.

The random-access configuration information may be transmitted using a respective prach-ConfigurationIndex information element for each of the plurality of the PRACH preamble formats. The random-access configuration information may be transmitted using a respective rach-ConfigGeneric information element for each of the plurality of the PRACH preamble formats.

The method performed by the UE may further comprise applying, based on the random-access configuration information, a specific PRACH preamble format in a subsequent random-access preamble in the random-access procedure, wherein:
the specific PRACH preamble format is the same as a RACH preamble format used in a previous random-access attempt; or
the specific PRACH preamble format is different to a RACH preamble format used in a previous random-access attempt and uses the same power ramping counter as used in the previous random-access attempt; or
the specific PRACH preamble format is different to a RACH preamble format used in a previous random-access attempt and an associated power ramping counter is increased; or
the specific PRACH preamble format is different to a RACH preamble format used in a previous random-access attempt and the specific PRACH preamble format is transmitted at a lower transmission power than the RACH preamble format used in the previous random-access attempt; or
the specific PRACH preamble format is different to a RACH preamble format used in a previous random-access attempt and the specific PRACH preamble format has a higher number of repetitions or a longer PRACH sequence than the RACH preamble format used in the previous random-access attempt.

The random-access configuration information may be transmitted using a different respective rach-ConfigCommon information element for each of the plurality of the PRACH preamble formats.

The method performed by the UE may further comprise applying, based on the random-access configuration information, a specific PRACH preamble format in a subsequent random-access preamble in the random-access procedure, wherein:
the specific PRACH preamble format is the same as a RACH preamble format used in a previous random-access attempt; or
the specific PRACH preamble format is different to a RACH preamble format used in a previous random-access attempt and an associated power ramping counter is increased.

The random-access configuration information may respectively identify a plurality of entries of a PRACH configuration table for a plurality of uplink cells or uplink configurations. The random-access configuration information may identify, for at least one of the plurality of uplink cells or uplink configurations, at least one of: an associated power class; or an associated maximum transmission power level.

The plurality of uplink cells or uplink configurations may be configured with a common synchronization signal block transmission. The plurality of uplink cells or uplink configurations may have a common remaining minimum system information.

The random-access configuration information may be applicable to at least one non-terrestrial cell.

The at least one of the plurality of the PRACH preamble formats may be associated with a power class value of the UE or a maximum transmission power supported by the UE. The at least one of the plurality of the PRACH preamble formats may be associated with a standard release supported by the UE.

The respective resource may include at least one of: a resource block or a subcarrier in frequency domain; a subframe; a slot; or a symbol.

The random-access procedure may be a two-step random-access procedure, and the method may further comprise obtaining, by the UE from the access network node, for each RACH preamble format, information identifying a respective physical uplink shared channel (PUSCH) configuration for a first message (MsgA) of the two-step random-access procedure. In this case, each respective PUSCH configuration may identify at least one of: a number of PUSCH repetitions; a modulation and coding scheme for a PUSCH transmission; or a frequency and time allocation of PUSCH occasions.

The PUSCH configuration may be applicable to one or more specific PRACH format.

The at least one RACH preamble format or resource may be associated with coverage enhancement.

The method performed by the UE may further comprise: transmitting, to the access network node using the at least one RACH preamble format or resource associated with coverage enhancement, signalling for initiating a random-access procedure; and obtaining information identifying a PUSCH resource with coverage enhancement for transmitting a third message (Msg3) of a four-step random-access procedure.

The method performed by the UE may further comprise receiving information identifying a number of repetitions associated with the PUSCH resource with coverage enhancement via system information or via a downlink control information (DCI) for the PUSCH.

Various other modifications will be apparent to those skilled in the art and will not be described in further detail here.

Although the present invention has been described with reference to the exemplary example embodiments, the present invention is not limited to the above. Various changes that can be understood by those skilled in the art can be made to the configuration and details of the present invention within the scope of the invention.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.).

The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

This application is based upon and claims the benefit of priority from United Kingdom Patent Application No. 2206366.3, filed on Apr. 29, 2022, the disclosure of which is incorporated herein in its entirety by reference.

For example, the whole or part of the exemplary example embodiments disclosed above can be described as, but not limited to, the following supplementary notes.

### (Supplementary Note 1)

A method performed by a user equipment (UE), the method comprising: receiving, from an access network node, random-access configuration information for configuring the UE to perform random-access procedures, wherein the random-access configuration information identifies a plurality of physical random-access (PRACH) preamble formats for the UE in a random-access procedure, wherein each PRACH preamble format is associated with a respective resource within a period to which the random-access configuration information is applicable.

### (Supplementary Note 2)

The method according to supplementary note 1, wherein each PRACH preamble format is associated with a respective UE uplink transmission power.

### (Supplementary Note 3)

The method according to supplementary note 1 or 2, wherein the random-access configuration information indicates association between one or more of respective resources in a time domain within the period and the plurality of the PRACH preamble formats.

### (Supplementary Note 4)

The method according to any one of supplementary notes 1 to 3, wherein at least two of the plurality of the PRACH preamble formats are associated with the same frequency.

### (Supplementary Note 5)

The method according to any one of supplementary notes 1 to 4, wherein the random-access configuration information identifies, for each PRACH preamble format, a respective preamble received target power.

### (Supplementary Note 6)

The method according to supplementary note 5, wherein the preamble received target power is identified by at least one of an offset or a power value.

### (Supplementary Note 7)

The method according to any one of supplementary notes 1 to 6, further comprising:
transmitting, to the access network node, signalling for initiating a random-access procedure, the signalling comprising a random-access preamble having one of the plurality of the PRACH formats; and communicating with the access network node for completing the random-access procedure.

### (Supplementary Note 8)

The method according to supplementary note 7, further comprising selecting the one of the plurality of the PRACH formats based on at least one of a power class associated with the UE or a maximum transmission power supported by the UE.

### (Supplementary Note 9)

The method according to supplementary note 8, further comprising selecting the one of the plurality of the PRACH formats based on a physical downlink control channel (PDCCH) order.

### (Supplementary Note 10)

The method according to any one of supplementary notes 1 to 9, wherein the random-access configuration information identifies, for a cell, at least one entry of a PRACH configuration table, each of the at least one entry of a PRACH configuration table being associated with different one of the plurality of the PRACH preamble formats.

### (Supplementary Note 11)

The method according to supplementary note 10, wherein the random-access configuration information identifies at least one common parameter for the at least one entry.

### (Supplementary Note 12)

The method according to supplementary note 10 or 11, wherein the random-access configuration information identifies, for the at least one entry, one or more of the following:
an associated frequency offset and a number of frequency domain PRACH resources to perform frequency multiplexing of the PRACH preamble formats;
an associated preamble received target power;
an associated power ramping step;
an associated maximum number of random-access attempts;
an associated value for a zeroCorrelationZoneConfig information element; and
an associated value for a restrictedSetConfig information element.

### (Supplementary Note 13)

The method according to any one of supplementary notes 1 to 12, wherein the random-access configuration information is transmitted using a respective prach-ConfigurationIndex information element for each of the plurality of the PRACH preamble formats.

### (Supplementary Note 14)

The method according to any one of supplementary notes 1 to 13, wherein the random-access configuration information is transmitted using a respective rach-ConfigGeneric information element for each of the plurality of the PRACH preamble formats.

### (Supplementary Note 15)

The method according to any one of supplementary notes 1 to 14, further comprising:
applying, based on the random-access configuration information, a specific PRACH preamble format in a subsequent random-access preamble in the random-access procedure, wherein:
the specific PRACH preamble format is the same as a RACH preamble format used in a previous random-access attempt; or
the specific PRACH preamble format is different to a RACH preamble format used in a previous random-access attempt and uses the same power ramping counter as used in the previous random-access attempt; or
the specific PRACH preamble format is different to a RACH preamble format used in a previous random-access attempt and an associated power ramping counter is increased; or
the specific PRACH preamble format is different to a RACH preamble format used in a previous random-access attempt and the specific PRACH preamble format is transmitted at a lower transmission power than the RACH preamble format used in the previous random-access attempt; or
the specific PRACH preamble format is different to a RACH preamble format used in a previous random-access attempt and the specific PRACH preamble format has a higher number of repetitions or a longer PRACH sequence than the RACH preamble format used in the previous random-access attempt.

### (Supplementary Note 16)

The method according to any one of supplementary notes 1 to 9, wherein the random-access configuration information is transmitted using a different respective rach-ConfigCommon information element for each of the plurality of the PRACH preamble formats.

### (Supplementary Note 17)

The method according to supplementary note 16, further comprising: applying, based on the random-access configuration information, a specific PRACH preamble format in a subsequent random-access preamble in the random-access procedure, wherein:
the specific PRACH preamble format is the same as a RACH preamble format used in a previous random-access attempt; or
the specific PRACH preamble format is different to a RACH preamble format used in a previous random-access attempt and an associated power ramping counter is increased.

### (Supplementary Note 18)

The method according to any one of supplementary notes 1 to 9, 16, and 17, wherein the random-access configuration information respectively identifies a plurality of entries of a PRACH configuration table for a plurality of uplink cells or uplink configurations.

### (Supplementary Note 19)

The method according to supplementary note 18, wherein the random-access configuration information identifies, for at least one of the plurality of uplink cells or uplink configurations, at least one of:
an associated power class; or
an associated maximum transmission power level.

### (Supplementary Note 20)

The method according to supplementary note 18 or 19, wherein the plurality of uplink cells or uplink configurations is configured with a common synchronization signal block transmission.

### (Supplementary Note 21)

The method according to any one of supplementary notes 18 to 20, wherein the plurality of uplink cells or uplink configurations has a common remaining minimum system information.

### (Supplementary Note 22)

The method according to any one of supplementary notes 1 to 21, wherein the random-access configuration information is applicable to at least one non-terrestrial cell.

### (Supplementary Note 23)

The method according to any one of supplementary notes 1 to 22, wherein at least one of the plurality of the PRACH preamble formats is associated with a power class value of the UE or a maximum transmission power supported by the UE.

### (Supplementary Note 24)

The method according to any one of supplementary notes 1 to 23, wherein at least one of the plurality of the PRACH preamble formats is associated with a standard release supported by the UE.

### (Supplementary Note 25)

The method according to any one of supplementary notes 1 to 24, wherein the respective resource includes at least one of:
a resource block or a subcarrier in frequency domain;
a subframe;
a slot; or
a symbol.

### (Supplementary Note 26)

The method according to any one of supplementary notes 1 to 25, wherein
the random-access procedure is a two-step random-access procedure, and the method further comprises obtaining, for each RACH preamble format, information identifying a respective physical uplink shared channel (PUSCH) configuration for a first message (MsgA) of the two-step random-access procedure.

### (Supplementary Note 27)

The method according to supplementary note 26, wherein each respective PUSCH configuration identifies at least one of:
a number of PUSCH repetitions;
a modulation and coding scheme for a PUSCH transmission; or
a frequency and time allocation of PUSCH occasions.

### (Supplementary Note 28)

The method according to supplementary note 26 or 27, wherein the PUSCH configuration is applicable to one or more specific PRACH format.

### (Supplementary Note 29)

The method according to any one of supplementary notes 1 to 25, wherein at least one RACH preamble format or resource is associated with coverage enhancement.

### (Supplementary Note 30)

The method according to supplementary note 29, further comprising: transmitting, to the access network node using the at least one RACH preamble format or resource associated with coverage enhancement, signalling for initiating a random-access procedure; and obtaining information identifying a PUSCH resource with coverage enhancement for transmitting a third message (Msg3) of a four-step random-access procedure.

### (Supplementary Note 31)

The method according to supplementary note 30, further comprising receiving information identifying a number of repetitions associated with the PUSCH resource with coverage enhancement via system information or via a downlink control information (DCI) for the PUSCH.

### (Supplementary Note 32)

A method performed by an access network node, the method comprising: transmitting, to a user equipment (UE) random-access configuration information for configuring the UE to perform random-access procedures, wherein the random-access configuration information identifies a plurality of physical random-access (PRACH) preamble formats for the UE in a random-access procedure, wherein each PRACH preamble format is associated with a respective resource within a period to which the random-access configuration information is applicable.

### (Supplementary Note 33)

A user equipment (UE) comprising:
means for receiving, from an access network node, random-access configuration information for configuring the UE to perform random-access procedures, wherein the random-access configuration information identifies a plurality of physical random-access (PRACH) preamble formats for the UE in a random-access procedure,
wherein each PRACH preamble format is associated with a respective resource within a period to which the random-access configuration information is applicable.

### (Supplementary Note 34)

An access network node comprising:
means for transmitting, to a user equipment (UE) random-access configuration information for configuring the UE to perform random-access procedures, wherein the random-access configuration information identifies a plurality of physical random-access (PRACH) preamble formats for the UE in a random-access procedure,
wherein each PRACH preamble format is associated with a respective resource within a period to which the random-access configuration information is applicable.

### REFERENCE SIGNS LIST

1 telecommunication system
3 mobile device (user equipment, UE)
4 non-terrestrial platform
5 base station
7 data network
9 gateway

What is claimed is:

1. A method performed by a user equipment (UE), the method comprising:
receiving, from an access network node, random-access configuration information indicating a random-access configuration index corresponding to a plurality of physical random-access (PRACH) preamble formats for use by the UE in a random-access procedure,
wherein each of the plurality of the PRACH preamble formats corresponds to at least one respective random access occasion within a period to which the random-access configuration information is applicable, and
the each of the plurality of the PRACH preamble formats corresponds to a respective number of repetition.

2. The method according to claim 1, wherein the each of the plurality of the PRACH preamble formats corresponds to a respective UE uplink transmission power.

3. The method according to claim 1, further comprising:
selecting one of the plurality of the PRACH preamble formats for use by the random-access procedure, based on UE uplink transmission power corresponding to the one of the plurality of the PRACH preamble formats.

4. The method according to claim 1, wherein the random-access configuration information identifies, for each of the plurality of the PRACH preamble formats, a respective preamble received target power.

5. The method according to claim 4, wherein the preamble received target power corresponds to at least one of an offset or a power value.

6. The method according to claim 3, wherein the selecting the one of the plurality of the PRACH formats is performed based on at least one of a power class corresponding to the UE or a maximum transmission power supported by the UE.

7. The method according to claim 6, further comprising:
sending information indicating at least one of the power class corresponding to the UE or the maximum transmission power supported by the UE,
wherein the random-access configuration information is based on the at least one of the power class corresponding to the UE or the maximum transmission power supported by the UE.

8. The method according to claim 7, further comprising:
sending information indicating that the UE is not able to connect to a cell in coverage due to low PRACH power,
wherein the random-access configuration information is based on the information indicating that the UE is not able to connect to the cell in coverage due to low PRACH power.

9. The method according to claim 6, wherein the random-access configuration information indicates the plurality of the PRACH preamble formats per at least one of the power class or the maximum transmission power.

10. The method according to claim 1, wherein the random-access configuration information indicates association between at least one respective resource in a time domain within the period and each of the plurality of the PRACH preamble formats.

11. The method according to claim 1, wherein at least two of the plurality of the PRACH preamble formats correspond to the same frequency.

12. (canceled)

13. The method according to claim 1, further comprising:
mapping, for each of the plurality of the PRACH preamble formats, a synchronization signal and block to a respective random-access configuration index.

14. The method according to claim 1, further comprising:
indicating one of the plurality of the PRACH formats for the UE in using in a random-access procedure, via a physical downlink control channel (PDCCH) order.

15. The method according to claim 1, wherein the random-access configuration information includes a respective rach-ConfigGeneric information element or a respective rach-ConfigCommon information element, for each of the plurality of the PRACH preamble formats.

16. The method according to claim 1, wherein
the random-access configuration information includes a single index [identifying] indicating an entry of a PRACH configuration table, and
the entry of the PRACH configuration table identifies a respective time occasion for each of the plurality of the PRACH preamble formats.

17. The method according to claim 1, wherein the random-access configuration information indicates association between at least one respective resource in a frequency domain and each of the plurality of the PRACH preamble formats.

18. The method according to claim 17, wherein at least two of the plurality of the PRACH preamble formats are overlapped in time domain.

19-35. (canceled)

36. A method performed by an access network node, the method comprising:
transmitting, to a user equipment (UE), random-access configuration information indicating a random-access configuration index corresponding to a plurality of physical random-access (PRACH) preamble formats for use by the UE in a random-access procedure,
wherein each of the plurality of the PRACH preamble formats corresponds to at least one respective random access occasion within a period to which the random-access configuration information is applicable, and
the each of the plurality of the PRACH preamble formats corresponds to a respective number of repetition.

37. A user equipment (UE) comprising:
at least one memory storing instructions; and
at least one processor configured to execute the instructions to:
receive, from an access network node, random-access configuration information indicating a random-access configuration index corresponding to a plurality of physical random-access (PRACH) preamble formats for use by the UE in a random-access procedure,
wherein each of the plurality of the PRACH preamble formats corresponds to at least one respective random access occasion within a period to which the random-access configuration information is applicable, and
the each of the plurality of the PRACH preamble formats corresponds to a respective number of repetition.

38. An access network node comprising:
at least one memory storing instructions; and
at least one processor configured to execute the instructions to:
transmit, to a user equipment (UE), random-access configuration information indicating a random-access configuration index corresponding to a plurality of physical random-access (PRACH) preamble formats for use by the UE in a random-access procedure,
wherein each of the plurality of the PRACH preamble formats corresponds to at least one respective random access occasion within a period to which the random-access configuration information is applicable, and
the each of the plurality of the PRACH preamble format corresponds to a respective number of repetition.
